(19) United States
(12) Patent Application Publication
(10) Pub. No.: US 2012/0113141 A1
(43) Pub. Date: May 10, 2012

(54) TECHNIQUES TO VISUALIZE PRODUCTS USING AUGMENTED REALITY

(75) Inventors: Christina Zimmerman, Oakland, CA (US); Ryan Amundson, San Mateo, CA (US)

(73) Assignee: CBS INTERACTIVE INC., San Francisco, CA (US)

(21) Appl. No.: 12/942,727

(22) Filed: Nov. 9, 2010

(51) Int. Cl. G09G 5/00

(52) U.S. Cl. 345/633

(57) ABSTRACT

Techniques to visual products using augmented reality are described. An apparatus may comprise an augmentation system having a pattern detector component operative to receive an image with a first virtual object representing a first real object, and determine a location parameter and a scale parameter for a second virtual object based on the first virtual object, an augmentation component operative to retrieve the second virtual object representing a second real object from a data store, and augment the first virtual object with the second virtual object based on the location parameter and the scale parameter to form an augmented object, and a rendering component operative to render the augmented object in the image with a scaled version of the second virtual object as indicated by the scale parameter at a location on the first virtual object as indicated by the location parameter. Other embodiments are described and claimed.

### BACKGROUND

Online shopping is becoming more prevalent. With a computer and a network connection, a user can read product reviews, compare features and prices, order a product, and have it shipped to a location, all without ever leaving home. Despite such conveniences offered by an electronic store, however, a number of consumers prefer to visit a physical store. A physical store offers consumers an opportunity to touch and handle items, view items from different angles, compare sizes and textures, and receive other sensory feedback. In order for electronic stores to provide comparable advantages, enhanced techniques are needed to allow a consumer sensory feedback traditionally offered by physical stores. It is with respect to these and other considerations that the present improvements have been needed.

### BRIEF DESCRIPTION OF THE DRAWINGS

FIG. 1 illustrates an embodiment of an augmented reality system.

FIG. 2A illustrates an embodiment of a first image.

FIG. 2B illustrates an embodiment of a first augmented image.

FIG. 3 illustrates an embodiment of a distributed system.

FIG. 4 illustrates an embodiment of a centralized system.

FIG. 5A illustrates an embodiment of a second image.

FIG. 5B illustrates an embodiment of a second augmented image.

FIG. 5C illustrates an embodiment of a third augmented image.

FIG. 6 illustrates an embodiment of a logic flow for an augmentation system.

FIG. 7 illustrates an embodiment of a computing architecture.

FIG. 8 illustrates an embodiment of a communications architecture.

### DETAILED DESCRIPTION

Various embodiments are generally directed to techniques for visualizing objects, such as consumer products, using augmented reality techniques. Some embodiments are particularly directed to enhanced visualization techniques for creating augmented reality images suitable for online shopping at electronic stores. The augmented reality images may provide visual information such as location, scale or orientation of one virtual object relative to another virtual object. The virtual objects may comprise digital representations of real objects. For instance, a consumer may capture a digital image of a consumer's real hand, and create an augmented reality image of how a digital image of a cellular telephone may fit within the digital image of the consumer's hand. In this manner, a consumer may visualize how the cellular telephone would fit in a palm of the consumer's hand, a size for the cellular telephone relative to the consumer's hand, whether certain buttons or keys of the cellular telephone can be reached by various fingers of the consumer's hand, how the cellular phone may look at different angles while being held in the consumer's hand, and so forth. As a result, the enhanced visualization techniques may provide greater amounts of visual information about a consumer product to assist a consumer in deciding whether to purchase the consumer product from a physical or electronic store.

In one embodiment, for example, an apparatus such as a computing device may comprise a processor and memory. The memory may store an augmentation system for execution by the processor. The augmentation system may comprise a pattern detector component operative to receive an image with a first virtual object representing a first real object, and determine a location parameter and a scale parameter for a second virtual object based on the first virtual object. The augmentation system may further comprise an augmentation component operative to retrieve the second virtual object representing a second real object from a data store, and augment the first virtual object with the second virtual object based on the location parameter and the scale parameter to form an augmented object. The augmentation system may further comprise a rendering component operative to render the augmented object in the image with a scaled version of the second virtual object as indicated by the scale parameter at a location on the first virtual object as indicated by the location parameter. Other embodiments are described and claimed.

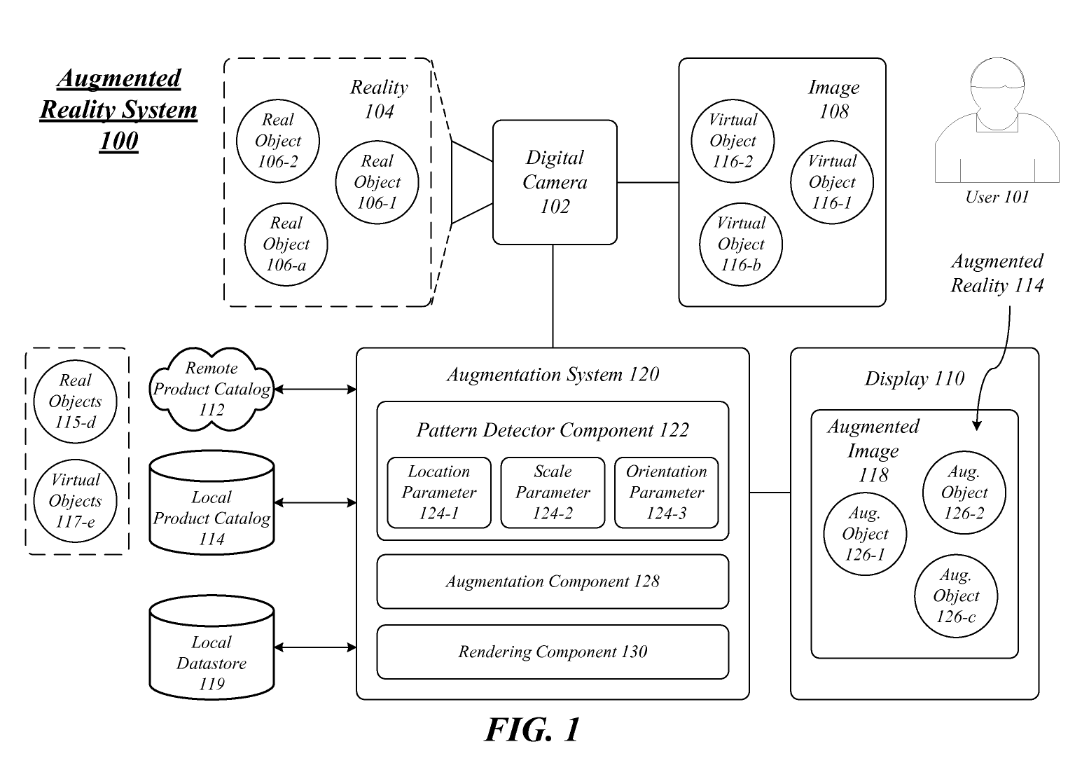

FIG. 1 illustrates a block diagram for an augmented reality system 100. In one embodiment, for example, the augmented reality system 100 may comprise an augmentation system 120. In one embodiment, the augmentation system 120 may comprise a computer-implemented system having multiple components 122, 124, 126, 128 and 130. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

The augmented reality system 100 includes various hardware and software elements designed to implement various augmented reality techniques. In general, augmented reality techniques attempt to merge or “augment” a physical environment with a virtual environment to enhance user experience in real-time. Augmented reality techniques may be used to overlay computer-generated information over images of a real-world environment. Augmented reality techniques employ the use of video imagery of a physical real-world environment which is digitally processed and modified with the addition of computer-generated information and graphics. For example, a conventional augmented reality system may employ specially-designed translucent goggles that enable a user to see the real world as well as computer-generated images projected over the real world vision. Other common uses of augmented reality systems are demonstrated through professional sports, where augmented reality techniques are used to project virtual advertisements upon a playing field or court, first down or line of scrimmage markers upon a football field, or a “tail” following behind a hockey puck showing a location and direction of the hockey puck.

In the illustrated embodiment shown in FIG. 1, the augmented reality system 100 and/or the augmentation system 120 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, gaming device, machine, or some combination thereof. Although the augmented reality system 100 as shown in FIG. 1 has a limited number of elements in a certain topology, it may be appreciated that the augmented reality system 100 may include more or less elements in alternate topologies as desired for a given implementation.

The components 122, 128 and 130 may be communicatively coupled via various types of communications media. The components 122, 128 and 130 may coordinate operations between each other. The coordination may involve the uni-directional or bi-directional exchange of information. For instance, the components 122, 128 and 130 may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 1, the augmented reality system 100 may comprise a digital camera 102, an augmentation system 120 and a display 110. The augmented reality system 100 may further comprise other elements typically found in an augmented reality system or an electronic device, such as computing components, communications components, power supplies, input devices, output devices, and so forth. The embodiments are not limited in this context.

The digital camera 102 may comprise any camera designed for digitally capturing still or moving images (e.g., pictures or video) using an electronic image sensor. An electronic image sensor is a device that converts an optical image to an electrical signal, such as a charge-coupled device (CCD) or a complementary metal-oxide-semiconductor (CMOS) active-pixel sensor. The digital camera 102 may also be capable of recording sound as well. The digital camera 102 may offer any technical features typically implemented for a digital camera, such as built-in flash, zoom, autofocus, live preview, and so forth.

The display 110 may comprise any electronic display for presentation of visual, tactile or auditive information. Examples for the display 110 may include without limitation a cathode ray tube (CRT), bistable display, electronic paper, nixie tube, vector display, a flat panel display, a vacuum fluorescent display, a light-emitting diode (LED) display, electroluminescent (ELD) display, a plasma display panel (PDP), a liquid crystal display (LCD), a thin-film transistor (TFT) display, an organic light-emitting diode (OLED) display, a surface-conduction electron-emitter display (SED), a laser television, carbon nanotubes, nanocrystal displays, a head-mounted display, and so any other displays consistent with the described embodiments. In one embodiment, the display 110 may be implemented as a touchscreen display. A touchscreen display is an electronic visual display that can detect the presence and location of a touch within the display area. The touch may be from a finger, hand, stylus, light pen, and so forth. The embodiments are not limited in this context.

A user 101 may utilize the digital camera 102 to capture or record still or moving images 108 of a real-world environment referred to herein as reality 104. The reality 104 may comprise one or more real objects 106-a. Examples of real objects 106-a may include any real-world objects, including buildings, vehicles, people, and so forth. The digital camera 102 may capture or record various real objects 106-a of the reality 104 and generate the image 108. The image 108 may comprise an image of one or more virtual objects 116-b. Each of the virtual objects 116-b may comprise a digital or electronic representation of a corresponding real object 106-a. For instance, a real object 106-1 may comprise a building while a virtual object 116-1 may comprise a digital representation of the building. The image 108 may be used as input for the augmentation system 120.

It is worthy to note that “a” and “b” and “c” and similar designators as used herein are intended to be variables representing any positive integer. Thus, for example, if an implementation sets a value for a=5, then a complete set of real objects 106-a may include real objects 106-1, 106-2, 106-3, 106-4 and 106-5. The embodiments are not limited in this context.

In various embodiments, the augmentation system 120 may be generally arranged to receive and augment one or more images 108 with computer-generated information for one or more individuals to form one or more augmented images 118. The augmentation system 120 may implement various augmented reality techniques to overlay, annotate, modify or otherwise augment an image 108 having virtual objects 116-b representing real objects 106-a from a real-world environment such as reality 104 with one or more virtual objects 117-e representing other real objects 115-d, such as consumer products or commercial products. In this manner, a user 101 may receive a real-world image as represented by the reality 104 and captured by the digital camera 102, and view consumer or commercial products located within the real-world image in real-time.

In various embodiments, the augmentation system 120 may be generally arranged to receive and augment one or more of the virtual objects 116-b of the image 108 with one or more virtual objects 117-e. Along with the image 108, the virtual objects 117-e may be used as input for the augmentation system 120. Each of the virtual objects 117-e may comprise a two-dimensional (2D) or three-dimensional (3D) digital or electronic model of a corresponding real object 115-d. The real objects 115-d may comprise any item or product typically found in a physical store or an electronic store. In one embodiment, for example, the real objects 115-d may comprise a class of commercial products referred to herein as “consumer products.” For instance, a real object 115-d may comprise a consumer product (e.g., a cell phone, a television, a computer, and so forth) while a virtual object 117-e may comprise a digital representation of the consumer product. Although some embodiments are described with the real objects 115-d as consumer products, however, the real objects 115-d may represent any real world item, and the embodiments are not limited in this context.

The virtual objects 117-e may be stored as part of a remote product catalog 112 or a local product catalog 114. A product catalog may comprise various 2D or 3D digital models of various consumer products. Each product catalog may be associated with a given commercial entity, such as a given physical store, electronic store, or a combination of both. Each product catalog may be periodically updated with different virtual objects 117-e as typically found in a shopping experience. In one embodiment, the virtual objects 117-e may comprise part of a remote product catalog 112 stored by a remote device accessible via a network. In one embodiment, the virtual objects 117-e may comprise part of a local product catalog 114 stored by a local device implementing the augmentation system 120.

As shown, the augmentation system 120 may comprise a pattern detector component 122, an augmentation component 128, and a rendering component 130. However, the augmentation system 120 may include more or less components for a given implementation.

The augmentation system 120 may comprise the pattern detector component 122. The pattern detector component 122 may be generally arranged to determine various parameters 124-f about the real objects 106-a, 115-d and/or the virtual objects 116-b, 117-e. In various embodiments, the parameters 124-f may represent various attributes or characteristics about the virtual objects 116-b, 117-e that may assist in combining the virtual objects 116-b, 117-e into one or more augmented objects 126-c. In one embodiment, for example, the parameters 124-f may include without limitation a location parameter 124-1, a scale parameter 124-2 and an orientation parameter 124-3. Other implementations may use other parameters 124-f, and the embodiments are not limited in this context.

The parameters 124-f may represent various measurable characteristics of the real objects 106-a, 115-d and/or the virtual objects 116-b, 117-e. The measurable characteristics may include without limitation such dimensions as height, width, depth, weight, angles, circumference, radius, location, geometry, orientation, speed, velocity, and so forth. For the real objects 106-a, a set of one or more measurable characteristics may be determined using a defined pattern placed somewhere on the real objects 106-a. Additionally or alternative, a set of one or more measurable characteristics may be determined using information for real objects 106-a stored in a local data store 119. For the real objects 115-d, a set of one or more measurable characteristics may be determined using information for the real objects 115-d stored in the remote product catalog 112 and/or the local product catalog 114.

For the real objects 106-a, a set of one or more measurable characteristics may be determined using a defined pattern placed somewhere on or near a real object 106-a. A defined pattern may comprise a printed pattern on a tangible medium, such as printer or copier paper. A defined pattern may optionally have adhesive on one side to allow adhesion to a selected real object 106-a. A defined pattern has attributes or characteristics that are known by the pattern detector component 128. As such, a defined pattern may provide information to the pattern detector component 128, which can be used to derive or estimate certain information about the real objects 106-a, 115-d and/or the virtual objects 116-b, 117-e. For instance, a defined pattern may have known dimensions, such as height or width. A defined pattern may have a type of pattern that is easily detected among the real objects 106-a using machine-vision or computer-vision. A defined pattern may have a type of pattern that allows the pattern detector component 128 to detect an orientation of the defined pattern along a given axis in 3D space. A defined pattern may have a type of pattern encoded with information that is retrievable by the pattern detector component 128, such as a pattern type, a pattern name, certain information about the real objects 106-a, 115-d and/or the virtual objects 116-b, 117-e (e.g., dimensions, names, metadata, etc.). A defined pattern may be disposed on any tangible medium and may have any size or shape suitable for a given implementation. The embodiments are not limited in this context.

The user 101 and/or the augmentation system 120 may automatically or manually select a particular defined pattern for a given real object 106-a, and cause the defined pattern to be converted into physical form, such as by using a printer or other output device to reproduce the defined pattern in tangible form. Once printed, a defined pattern may be physically placed somewhere on or near the real object 106-a. When the digital camera 102 captures the image 108 with the real object 106-a having the defined pattern disposed thereon, the pattern detector component 122 may detect and analyze the defined pattern to determine various measurable characteristics for the real object 106-a, such as a precise location on or near the real object 106-a, a size or scale for the real object 106-a, an orientation for real object 106-a, and so forth. These measurable characteristics may be encoded into one or more corresponding parameters 124-f.

The location parameter 124-1 may represent a location in 2D or 3D space on or near a real object 106-a. The location may be represented by coordinates for a 2D or 3D coordinate system, such as a Cartesian coordinate system, a Polar coordinate system, a Homogeneous coordinate system, and so forth. For instance, assume a real object 106-a is a wall in a room of a house. A defined pattern may be attached somewhere on the wall, such as where a digital television might be placed on the wall. The pattern detector component 122 may detect the defined pattern on the wall, and use the position of the defined pattern on the wall to calculate coordinates for a 2D or 3D location on the wall. The coordinates may be encoded as the location parameter 124-1, and the location parameter 124-1 may be used for augmenting the image 108 having a virtual object 116-b of the wall with a virtual object 117-e representing a digital television on the virtual object 116-b.

The scale parameter 124-2 may represent a size for a real object 106-a. For instance, a defined pattern may be disposed on a real object 106-a. The defined pattern may have defined dimensions, including a height and a width. The pattern detector component 122 may detect the defined pattern on a real object 106-a, and determine an approximate height and width of the real object 106-a based on a known height and width of the defined pattern. For instance, if the defined pattern has a 1″×1″ size, and the pattern detector component 122 calculates that a palm of a consumer's hand is approximately 9 defined patterns, then the pattern detector component 122 may calculate the palm as approximately 3″×3″ of surface area.

The orientation parameter 124-3 may represent an orientation for a real object 106-a. More particularly, the orientation parameter 124-3 may comprise an orientation of at least one axis of a virtual object 117-e as measured by a 2D or 3D coordinate system, such as a Cartesian coordinate system, a Polar coordinate system, a Homogeneous coordinate system, and so forth. For instance, a defined pattern may be disposed on a real object 106-a. The defined pattern may have a type of pattern suitable for calculating a given angle of orientation for the defined pattern based on a given coordinate system. The pattern detector component 122 may detect the defined pattern on a real object 106-a, and determine an approximate orientation of the real object 106-a based on a detected orientation of the defined pattern.

The augmentation component 128 may be generally arranged to receive as input various parameters 124-f from the pattern detector component 122. The augmentation component 128 may retrieve a virtual object 117-e representing a real object 115-d from the remote product catalog 112 or the local product catalog 114. The virtual object 117-e may be selected, for example, by the user 101 from the remote product catalog 112 or the local product catalog 114. The augmentation component 128 may then selectively augment a virtual object 116-b with the virtual object 117-e based on the input parameters 124-f to form an augmented object 126-c.

The rendering component 130 may be generally arranged to render an augmented image 118 corresponding to an image 108 with augmented objects 126-c. The rendering component 130 may receive a set of augmented objects 126-c corresponding to some or all of the virtual objects 116-b of the image 108. The rendering component 130 may selectively replace certain virtual objects 116-b with corresponding augmented objects 126-c. For instance, assume the image 108 includes five virtual objects (e.g., b=5) comprising virtual objects 116-1, 116-2, 116-3, 116-4 and 116-5. Further assume the augmentation component 128 has augmented the virtual objects 116-2, 116-4 to form corresponding augmented objects 126-2, 126-4. The rendering component 130 may selectively replace the virtual objects 116-2, 116-4 of the image 108 with the corresponding augmented objects 126-2, 126-4 to form the augmented image 118.

In one embodiment, the rendering component 130 may render the augmented image 118 in a first viewing mode to include both virtual objects 116-b and augmented objects 126c. Continuing with the previous example, the rendering component 130 may render the augmented image 118 to present the original virtual objects 116-1, 116-3, 116-5, and the augmented objects 126-2, 126-4. Additionally or alternatively, the augmented image 118 may draw viewer attention to the augmented objects 126-2, 126-4 using various GUI techniques, such as by graphically enhancing elements of the augmented objects 126-2, 126-4 (e.g., make them brighter), while subduing elements of the virtual objects 116-1, 116-3, 116-5 (e.g., make them dimmer or increase translucency). In this case, certain virtual objects 116-b and any augmented objects 126-c may be presented as part of the augmented image 118 on the display 110.

In one embodiment, the rendering component 130 may render the augmented image 118 in a second viewing mode to include only augmented objects 126c. Continuing with the previous example, the rendering component 130 may render the augmented image 118 to present only the augmented objects 126-2, 126-4. This reduces an amount of information provided by the augmented image 118, thereby simplifying the augmented image 118 and allowing the user 101 to view only the pertinent augmented objects 126c. Any virtual objects 116-b not replaced by augmented objects 126-c may be dimmed, made translucent, or eliminated completely from presentation within the augmented image 118, thereby effectively ensuring that only augmented objects 126-c are presented as part of the augmented image 118 on the display 110.

In one embodiment, the user 101 may selectively switch the rendering component 130 between the first and second viewing modes according to user preference.

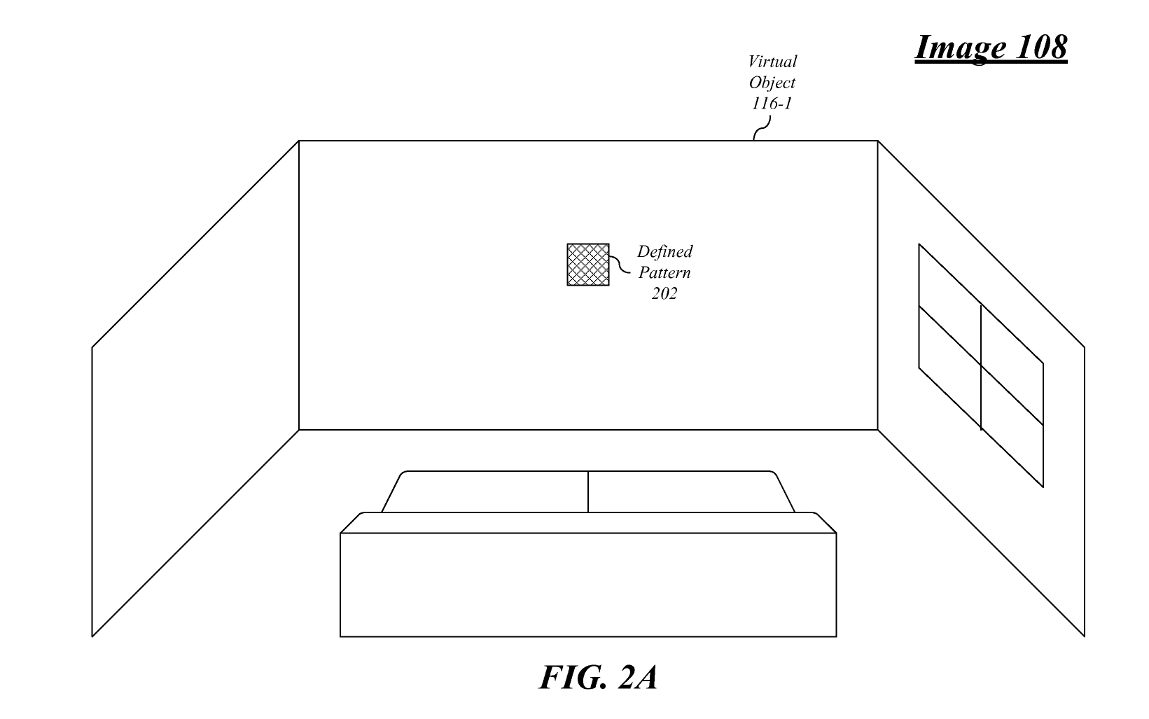

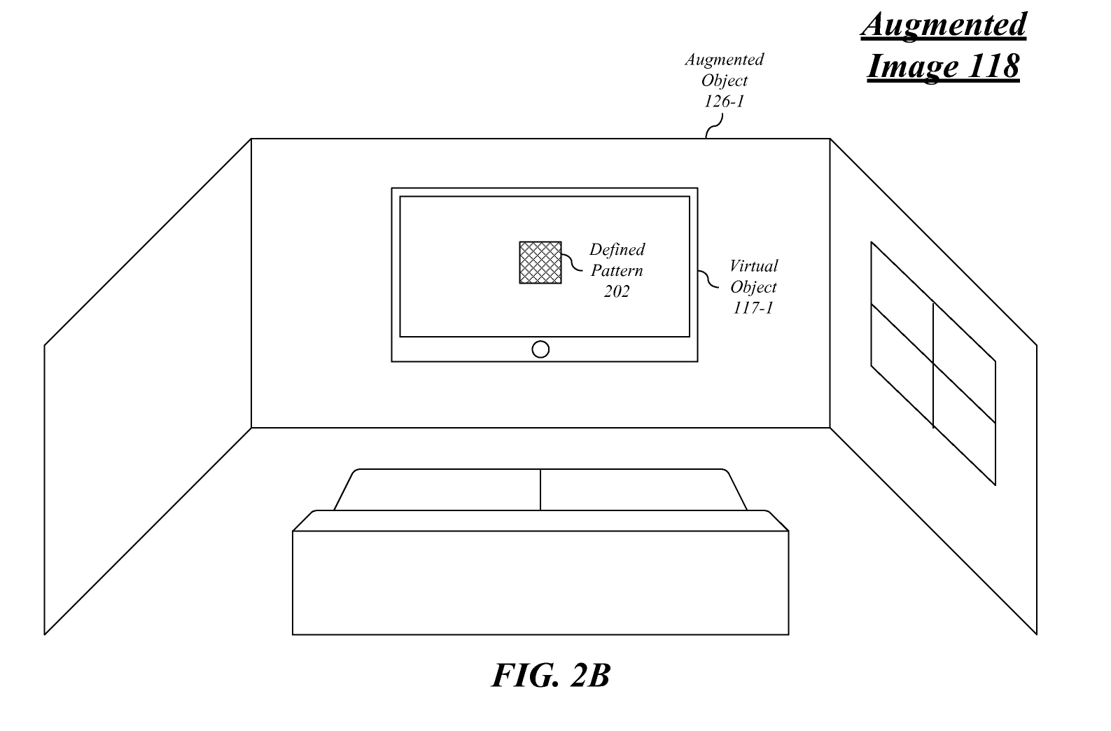

FIGS. 2A, 2B illustrate an example of how the user 101 may use the augmented reality system 100 to create an augmented image 118 to visualize how a digital television may look on a wall of a room in a home for the user 101. The user 101 may use the augmented image 118 to assist in making a purchasing decision from a physical store or an online store.

FIG. 2A illustrates an exemplary image 108 as captured by the digital camera 102. In the illustrated embodiment shown in FIG. 2A, the digital camera 102 captures an image 108 of a room in a house for the user 101. The image 108 includes a virtual object 116-1 comprising a digital representation of a real object 106-1 comprising a wall in the room. The virtual object 116-1 includes a digital representation of a defined pattern 202 actually disposed on the wall. Alternatively, the image 108 may include the virtual object 116-1 as retrieved from the local data store 119. For instance, the user 101 may have previously recorded the real object 106-1 with the defined pattern 202 in a previous image 108, and the augmentation system 120 may store the virtual object 116-1 and the defined pattern 202 in the local data store 119 for future use.

The pattern detector component 122 may be arranged to receive an image 108 with the first virtual object 116-1 representing the first real object 106-1. The pattern detector component 122 may determine a location parameter 124-1 and a scale parameter 124-2 for a second virtual object 117-1 based on the first virtual object 116-1. The second virtual object 117-1 may comprise, for example, a 2D or 3D model of a digital television suitable for hanging on the wall in the room.

The pattern detector component 122 may be operative to determine the location parameter 124-1 based on the defined pattern 202 disposed on the real object 106-1 (e.g., the physical wall), the defined pattern 202 indicating an approximate location for the second virtual object 117-1 (e.g., a digital representation for the digital television) proximate to the first virtual object 116-1 (e.g., a digital representation of the wall). In one embodiment, for example, the pattern detector component 122 may be operative to determine the scale parameter 124-2 based on the defined pattern 202 disposed on the first real object 106-1, the defined pattern indicating a size for the second virtual object 117-1 relative to the first virtual object 116-1. For instance, the pattern detector component 122 may determine an appropriate size or scale for the second virtual object 117-1 (e.g., a digital representation for the digital television) relative to the first virtual object 116-1 (e.g., a digital representation of the wall). The pattern detector component 122 may output the location parameter 124-1 and the scale parameter 124-2 to the augmentation component 128.

The augmentation component 128 may retrieve the second virtual object 117-1 representing the second real object 115-1 from the remote product catalog 112 or the local product catalog 114. The augmentation component 128 may augment (or overlay) the first virtual object 116-1 with the second virtual object 117-1 based on the location parameter 124-1 and the scale parameter 124-2 to form an augmented object 126-1. The augmentation component 128 may output the augmented object 126-1 to the rendering component 130.

FIG. 2B illustrates an exemplary augmented image 118 as captured by the digital camera 102 and augmented using the augmentation system 120. In the illustrated embodiment shown in FIG. 2B, the digital camera 102 captures an image 108 of a room in a house for the user 101. The image 108 includes a virtual object 116-1 comprising a digital representation of a real object 106-1 comprising a wall in the room. The virtual object 116-1 includes a digital representation of a defined pattern 202 actually disposed on the wall. The augmentation system 120 utilizes the defined pattern 202 to augment the virtual object 116-1 (e.g., a digital representation of the wall) of the image 108 with the virtual object 117-1 (e.g., a digital representation of the digital television) to form the augmented object 126-1 presented by the augmented image 118.

The rendering component 130 may render the augmented object 126-1 in an augmented image 118 having a scaled version of the second virtual object 117-1 as indicated by the scale parameter 124-2 at a location on the first virtual object 116-1 as indicated by the location parameter 124-1. For instance, the rendering component 130 may render the augmented object 126-1 having a scaled version of the second virtual object 117-1 (e.g., a digital representation of the digital television) as indicated by the scale parameter 124-2 at a location on the first virtual object 116-1 (e.g., a digital representation of the wall) as indicated by the location parameter 124-1.

The display 110 may present the augmented image 118 with the augmented object 126-1. The user 101 may then view the augmented object 126-1 on the display 110 to see how a digital television might look hanging on the wall of the room, with the digital television having an appropriate scale relative to the wall of the room. For instance, the user 101 may determine whether a given size of a digital television might fit a given size for the wall. It may be appreciated that this example is only one of many, and the user 101 may use the augmented reality system 100 to view any number and type of augmented objects 126-c on the display 110 to see how a consumer product may look in any setting captured by the digital camera 102, such as how clothes may look on the user 101, a piece of jewelry such as a watch on a wrist of the user 101, a size of a smart phone in a palm of the user 101, and numerous other use scenarios. The embodiments are not limited in this context.

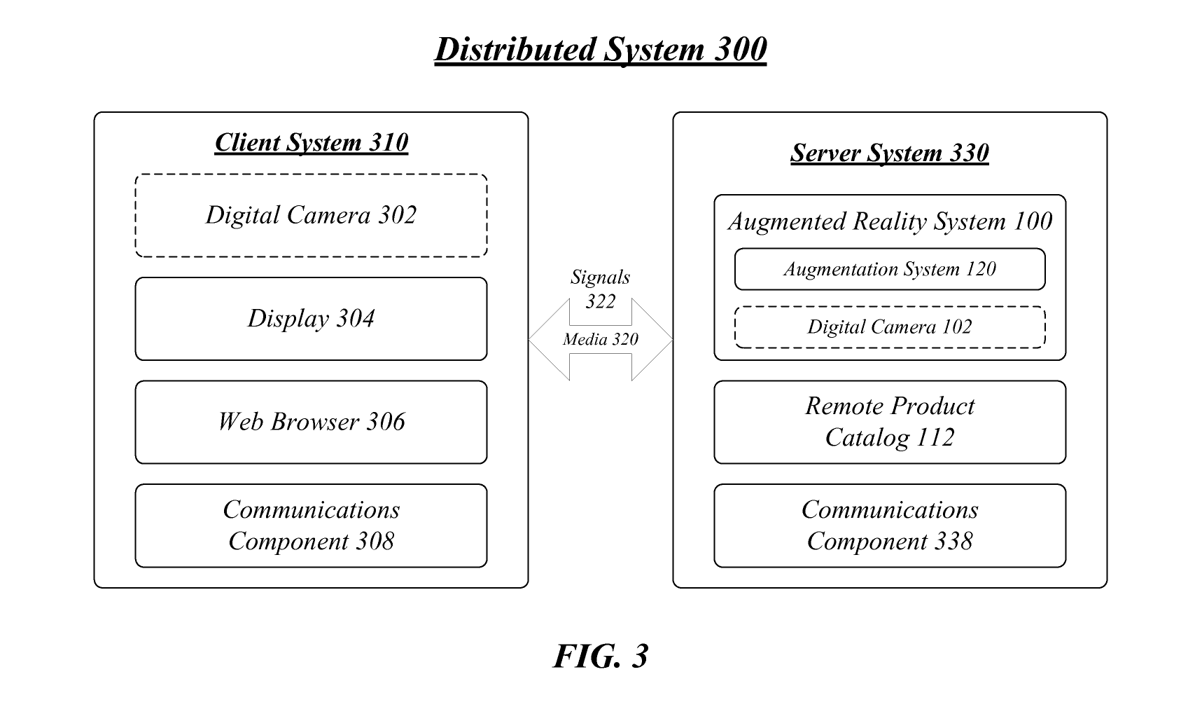

FIG. 3 illustrates a block diagram of a distributed system 300. The distributed system 300 may distribute portions of the structure and/or operations for the systems 100, 200 across multiple computing entities. Examples of distributed system 300 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, for example, the distributed system 300 may be implemented as a client-server system. A client system 310 may implement a digital camera 302, a display 304, a web browser 306, and a communications component 308. A server system 330 may implement some or all of the augmented reality system 100, such as the digital camera 102 and/or the augmentation system 120, and a communications component 338. The server system 330 may also store the remote product catalog 112.

In various embodiments, the client system 310 may comprise or implement portions of the augmented reality system 100, such as the digital camera 102 and/or the display 110. The client system 310 may comprise or employ one or more client computing devices and/or client programs that operate to perform various client operations in accordance with the described embodiments. Examples of the client system 310 may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the augmented reality system 100 as shown in FIG. 1 has a limited number of elements in a certain topology, it may be appreciated that the augmented reality system 100 may include more or less elements in alternate topologies as desired for a given implementation.

In various embodiments, the server system 330 may comprise or employ one or more server computing devices and/or server programs that operate to perform various server operations in accordance with the described embodiments. For example, when installed and/or deployed, a server program may support one or more server roles of the server computing device for providing certain services and features. Exemplary server systems 330 may include, for example, stand-alone and enterprise-class server computers operating a server operating system (OS) such as a MICROSOFT® OS, a UNIX® OS, a LINUX® OS, or other suitable server-based OS. Exemplary server programs may include, for example, communications server programs for managing incoming and outgoing messages, messaging server programs for providing unified messaging (UM) for e-mail, voicemail, VoIP, instant messaging (IM), group IM, enhanced presence, and audio-video conferencing, and/or other types of programs, applications, or services in accordance with the described embodiments.

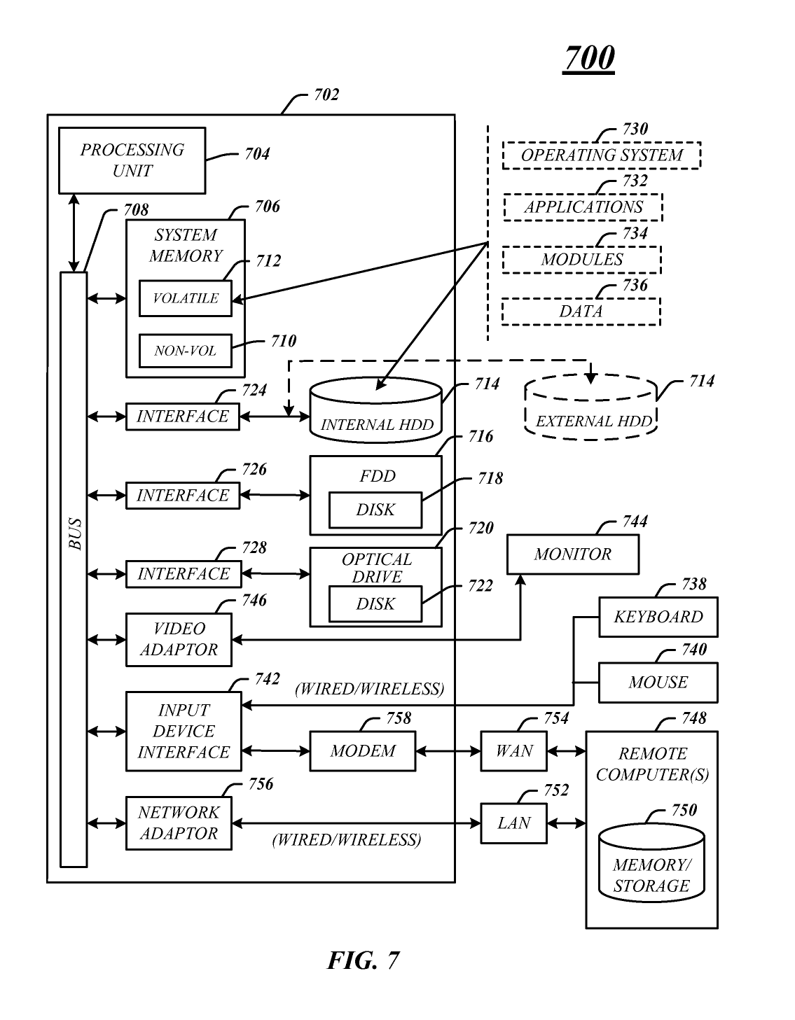

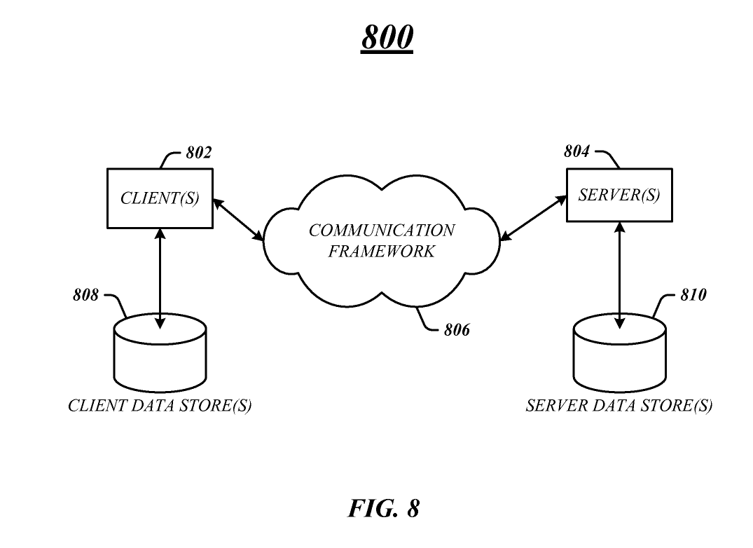

The client system 310 and the server system 330 may communicate with each over a communications media 320 using communications signals 322. In one embodiment, for example, the communications media may comprise a public or private network. In one embodiment, for example, the communications signals 322 may comprise wired or wireless signals. Computing aspects of the client system 310 and the server system 330 may be described in more detail with reference to FIG. 7. Communications aspects for the distributed system 300 may be described in more detail with reference to FIG. 8.

The distributed system 300 illustrates an example where the client system 310 implements input and output devices for the augmented reality system 100, while the server system 330 implements the augmentation system 120 to perform augmentation operations. As shown, the client system 310 may implement the digital camera 302 and the display 304 may be the same or similar as the digital camera 102 and the display 110 as described with reference to FIG. 1. The client system 310 may use the digital camera 302 to send or stream images 108 to the server system 330 as communications signals 322 over the communications media 320 via the communications component 308. The server system 330 may receive the images 108 from the client system 310 via the communications component 338, and perform augmentation operations for the images 108 to produce the augmented images 118 via the augmentation system 120 of the augmented reality system 100. The server system 330 may send the augmented images 118 as communications signals 322 over the communications media 320 to the client system 310. The client system 310 may receive the augmented images 118, and present the augmented images 118 on the display 304 of the client system 310.

The distributed system 300 also illustrates an example where the client system 310 implements only an output device for the augmented reality system 100, while the server system 330 implements the digital camera 102 to perform image capture operations and the augmentation system 120 to perform augmentation operations. In this case, the server system 330 may use the digital camera 102 to send or stream images 108 to the augmentation system 120. The augmentation system 120 may perform augmentation operations for the images 108 to produce the augmented images 118. The server system 330 may send the augmented images 118 as communications signals 322 over the communications media 320 to the client system 310 via the communications component 308, 338. The client system 310 may receive the augmented images 118, and present the augmented images 118 on the display 304 of the client system 310.

In the latter example, the augmented reality system 100 may be implemented as a web service accessible via the web browser 306. For instance, the user 101 may utilize the client system 310 to view augmented images 118 as provided by the augmented system 100 implemented by the server system 330. Examples of suitable web browsers may include MICROSOFT INTERNET EXPLORER®, GOOGLE® CHROME and APPLE® SAFARI, to name just a few. The embodiments are not limited in this context.

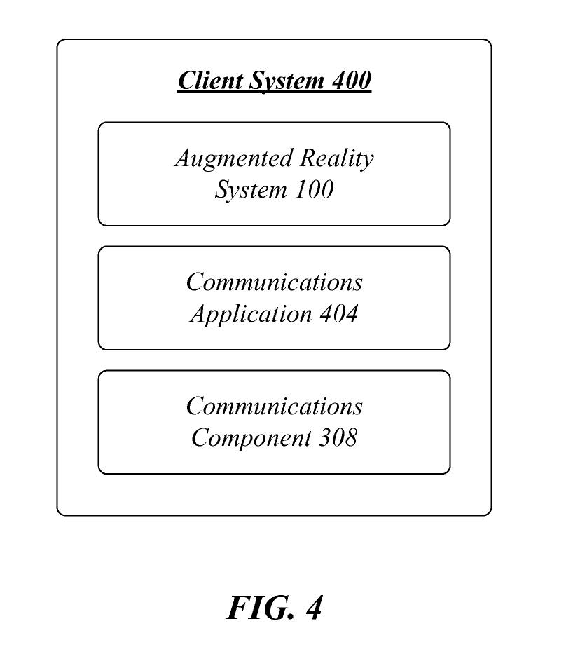

FIG. 4 illustrates a block diagram of a client system 400. The client system 400 may implement all of the structure and/or operations for the systems 100, 200 in a single computing entity. In one embodiment, for example, the client system 400 may implement the structure and/or operations for the systems 100, 200 entirely within a single computing device. The client system 400 may be representative of, for example, the client system 310 modified to include the augmented reality system 100 and one or more communications applications 404.

In the illustrated embodiment shown in FIG. 4, the client system 100 may comprise or implement the augmented reality system 100, a communications application 404, and a communications component 308. The communications application 404 may comprise any type of communications application for communicating with a device. Examples for the communications applications 404 may include without limitation a phone application and a messaging application. Examples of messaging applications may include without limitation a unified messaging (UM) application, an e-mail application, a voicemail application, an instant messaging (IM) application, a group IM application, presence application, audio-video conferencing application, short message service (SMS) application, multimedia message service (MMS) application, facsimile application and/or other types of messaging programs, applications, or services in accordance with the described embodiments.

As previously described, the augmentation system 120 may generate augmented objects 126-c to present an augmented image 118. The augmented image 118 may comprise a still image or images from a video. The augmented image 118 may be communicated from the client system 400 by the user 101 using one of the communications applications 404. For instance, the user 101 may desire to send an augmented image 118 of a watch on a wrist of the user 101 to a friend, or post an augmented image 118 of a car in a driveway of the user 101 to a social networking site (SNS). The embodiments are not limited in this context.

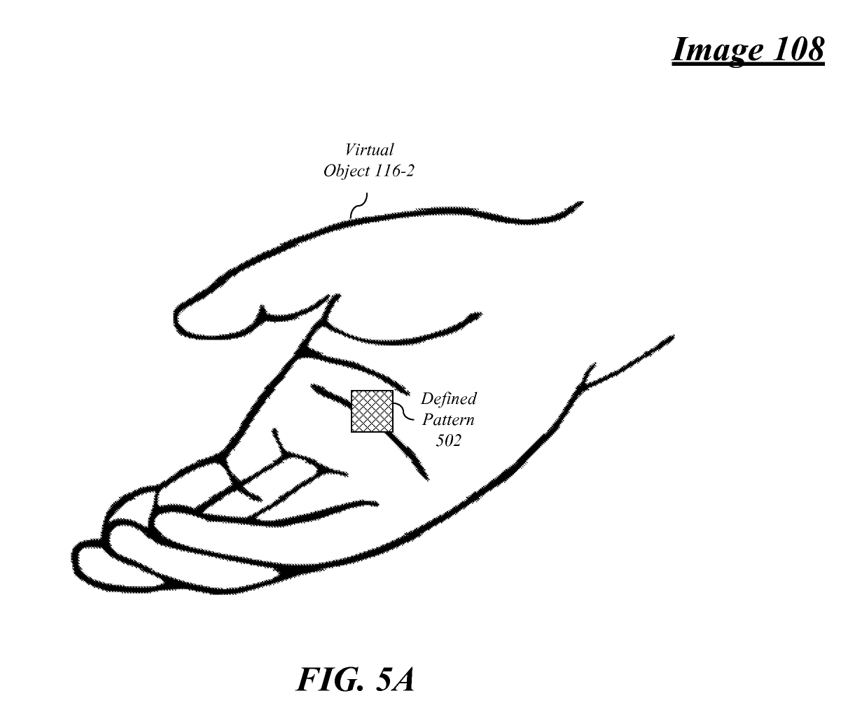

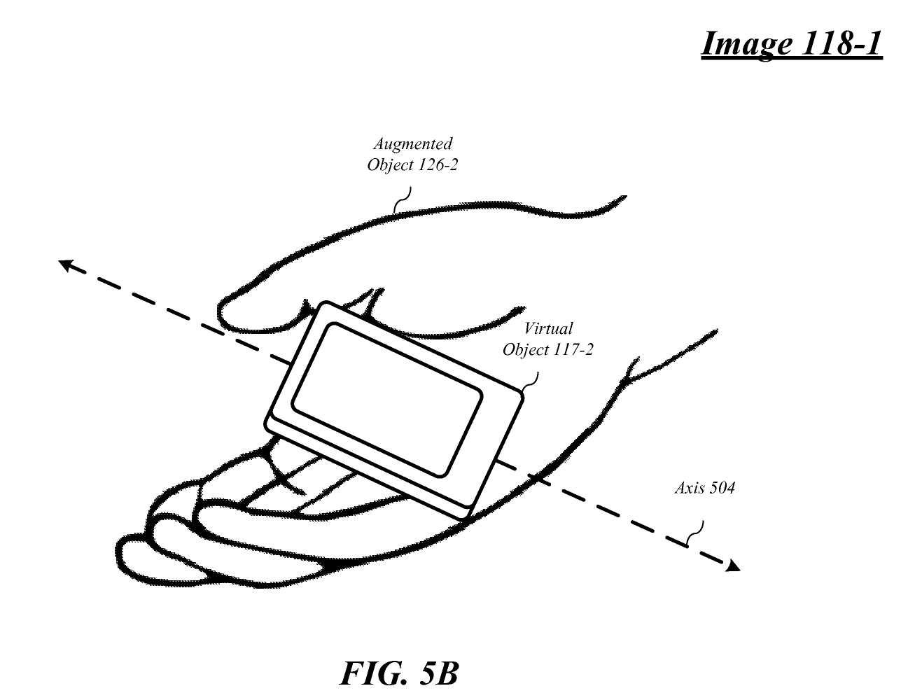

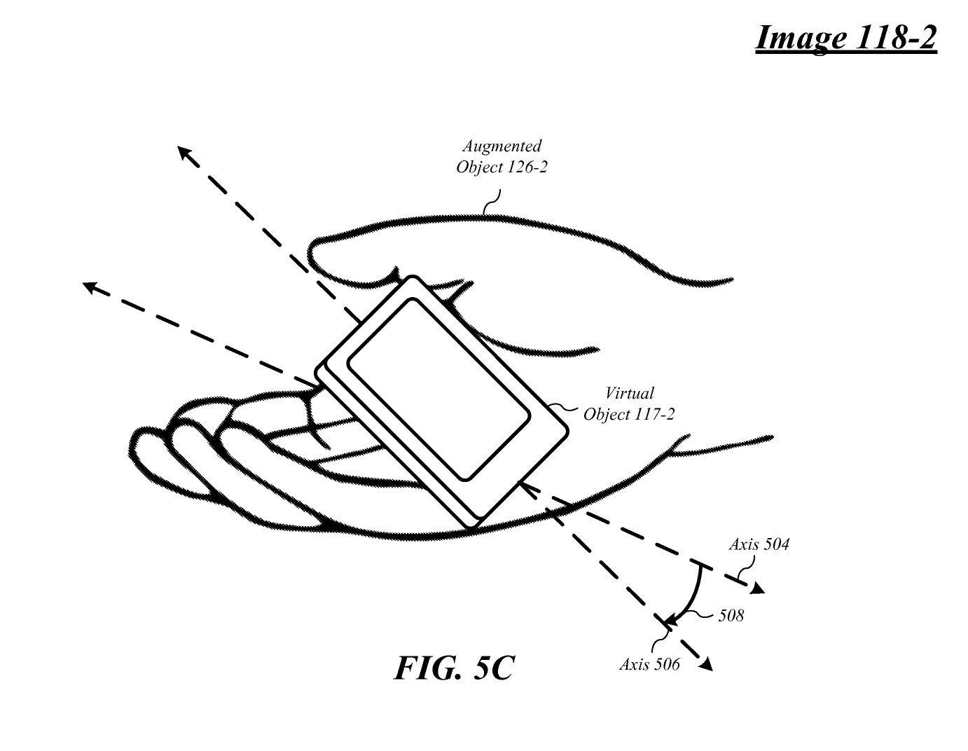

FIGS. 5A-5C illustrate an example of how the user 101 may use the augmented reality system 100 to generate an augmented image 118 to visualize how a cellular telephone may look when held in a hand of the user 101.

FIG. 5A illustrates an exemplary image 108 as captured by the digital camera 102. In the illustrated embodiment shown in FIG. 5A, the digital camera 102 captures an image 108 of a hand for the user 101. The image 108 includes a virtual object 116-2 comprising a digital representation of a real object 106-2 comprising a hand for the user 101. The virtual object 116-2 includes a digital representation of a defined pattern 502 actually disposed in the approximate center of a palm of the hand for the user 101.

The pattern detector component 122 may be arranged to receive an image 108 with the first virtual object 116-2 representing the first real object 106-2. The pattern detector component 122 may determine a location parameter 124-1 and a scale parameter 124-2 for a second virtual object 117-2 based on the first virtual object 116-1. The second virtual object 117-2 may comprise, for example, a 2D or 3D rendering of a cellular telephone suitable for placement in the hand of the user 101.

The pattern detector component 122 may be operative to determine the location parameter 124-1 based on the defined pattern 502 disposed on the real object 106-2 (e.g., a hand), the defined pattern 502 indicating an approximate location for the second virtual object 117-2 (e.g., a digital representation for the cellular telephone) disposed on the first virtual object 116-2 (e.g., a digital representation of the hand). In one embodiment, for example, the pattern detector component 122 may be operative to determine the scale parameter 124-2 based on the defined pattern 502 disposed on the first real object 106-1, the defined pattern indicating a size for the second virtual object 117-2 relative to the first virtual object 116-2. For instance, the pattern detector component 122 may determine an appropriate size or scale for the second virtual object 117-2 (e.g., a digital representation for the cellular telephone) relative to the first virtual object 116-2 (e.g., a digital representation of the hand).

The augmentation component 128 may retrieve the second virtual object 117-2 representing the second real object 115-2 from the remote product catalog 112 or the local product catalog 114. The augmentation component 128 may augment (or overlay) the first virtual object 116-2 with the second virtual object 117-2 based on the location parameter 124-1 and the scale parameter 124-2 to form an augmented object 126-2. The augmentation component 128 may output the augmented object 126-2 to the rendering component 130.

FIG. 5B illustrates an exemplary augmented image 118-1 as captured by the digital camera 102 and augmented using the augmentation system 120. In the illustrated embodiment shown in FIG. 5B, the digital camera 102 captures an image 108 of a hand for the user 101. The image 108 includes a virtual object 116-2 comprising a digital representation of a real object 106-2 comprising a hand of the user 101. The virtual object 116-2 includes a digital representation of a defined pattern 502 actually disposed on the hand of the user 101. The augmentation system 120 utilizes the defined pattern 502 to augment the virtual object 116-2 (e.g., a digital representation of the hand) of the image 108 with the virtual object 117-2 (e.g., a digital representation of the cellular telephone) to form the augmented object 126-2 presented by the augmented image 118-1.

The rendering component 130 may render the augmented object 126-2 in an augmented image 118-1 having a scaled version of the second virtual object 117-2 as indicated by the scale parameter 124-2 at a location on the first virtual object 116-2 as indicated by the location parameter 124-1. For instance, the rendering component 130 may render the augmented object 126-2 having a scaled version of the second virtual object 117-2 (e.g., a digital representation of the cellular telephone) as indicated by the scale parameter 124-2 at a location on the first virtual object 116-2 (e.g., a digital representation of the hand) as indicated by the location parameter 124-1.

The display 110 may present the augmented image 118 with the augmented object 126-2. The user 101 may then view the augmented object 126-2 on the display 110 to see how a cellular telephone might look when held in his or her own hand, with the cellular telephone having the appropriate size and scale relative to his or her hand. The user 101 may then decide on whether to purchase the cellular telephone based on the enhanced visual information provided by the augmented image 118-1.

In addition to visualizing location and size for the virtual objects 117-e relative to the virtual objects 116-b, the augmentation system 120 may also provide different views for the virtual objects 117-e as orientation of the virtual objects 116-b, 117-e change. In one embodiment, the pattern detector component 122 may determine an orientation parameter 124-3 for a virtual object 117-e based on a defined pattern disposed on a real object 106-a. For instance, the augmented object 126-2 shown in FIG. 5B has the virtual object 117-2 placed over the virtual object 116-2 at an orientation defined by an axis 504. The pattern detector component 122 may determine axis 504 based on an orientation of the defined pattern 502.

FIG. 5C illustrates an exemplary augmented image 118-2 as captured by the digital camera 102 and augmented using the augmentation system 120. In the illustrated embodiment shown in FIG. 5C, the augmented image 118-2 is similar to the augmented image 118-1. However, the augmented image 118-2 illustrates a case where the user 101 has rotated his or her hand by a certain angle θ as indicated by the axis 504, the axis 504, and a circular arc 508 defined there between. The pattern detector component 122 may determine an orientation parameter 124-3 for the second virtual object 117-2 based on an angle of orientation of the defined pattern 502 disposed on the first real object 106-2, as indicated by the axis 504 for the augmented image 118-1. The defined pattern may indicate an angle of orientation for the second virtual object 117-2 that corresponds to an angle of orientation of the first virtual object 116-2. As the orientation of the first and second virtual objects 116-2, 117-2 change, as indicated by an axis 506, the augmentation system 120 may update an orientation for the virtual object 117-2 to match the new orientation of the virtual object 116-2 as indicated by the axis 506. As such, different views of the second virtual object 117-2 may be presented to the user 101 on the display 110. For instance, as the user 101 rotates a hand, different 2D/3D views of the cellular telephone held in the palm of the hand may be shown, such as a bottom view of the cellular telephone, a top view of the cellular telephone, a side view of the cellular telephone, and so forth.

Continuing with this example, the augmentation component 128 may augment the first virtual object 116-2 with the second virtual object 117-2 based on the location parameter 124-1, the scale parameter 124-2 and the orientation parameter 124-3 to form the augmented object 126-2. The rendering component 130 may then render the augmented object 126-2 in the image with a scaled version of the second virtual object 117-2 at the determined location on the first virtual object 116-2 with the determined orientation of the second virtual object 117-2 relative to the first virtual object 116-2. Further, the pattern detector component 122 may monitor the image 108 to determine any changes in the defined pattern 502 disposed on the first real object 106-2. When a change is detected, the pattern detector component 122 may determine a new location parameter 124-1 and a new orientation parameter 124-3 based on the change in the defined pattern 502 disposed on the first real object 106-2. The augmentation component 128 may then augment the first virtual object 116-2 with the second virtual object 117-2 based on the new location parameter 124-1 and the new orientation parameter 124-3 to form a new augmented object 126-2.

In addition to creating an augmented image 118, the augmentation system 120 may further provide controls for manipulating the augmented image 118. For instance, the controls may allow the user 101 to zoom-in and zoom-out of the augmented objects 126c, move or rotate the augmented objects 126c, change perspective views of the augmented objects 126c, and other tools suitable for modifying an image.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

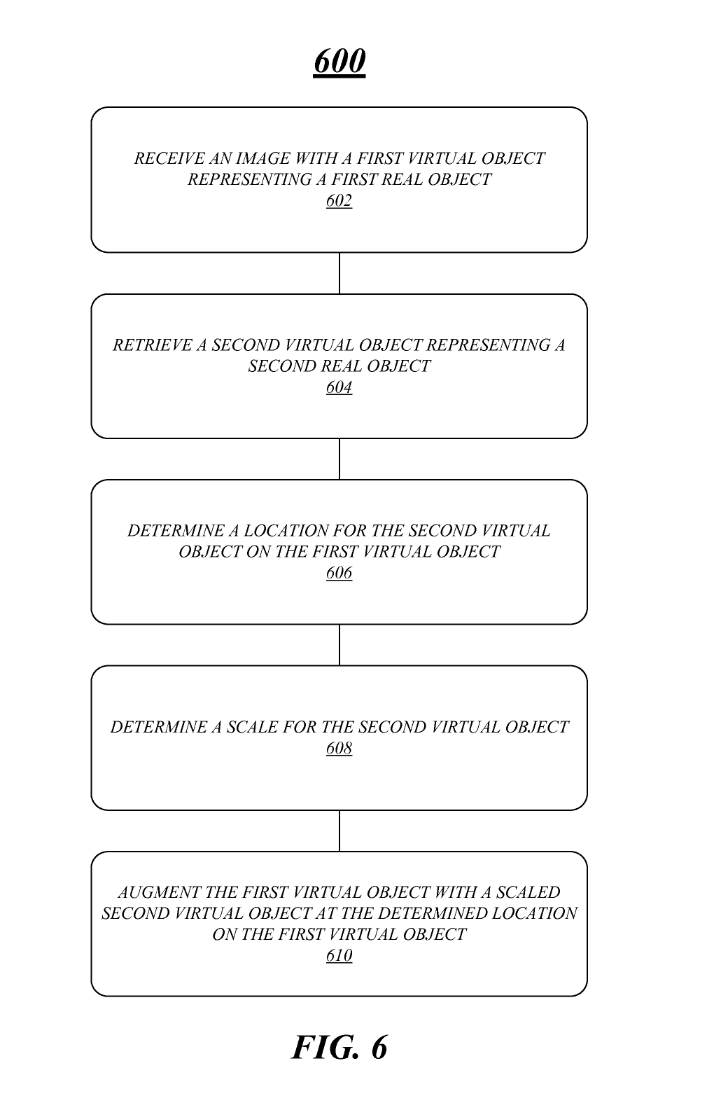

FIG. 6 illustrates one embodiment of a logic flow 600. The logic flow 600 may be representative of some or all of the operations executed by one or more embodiments described herein, such as the augmentation system 120, for example.

In the illustrated embodiment shown in FIG. 6, the logic flow 600 may receive an image with a first virtual object representing a first real object at block 602. For example, the pattern detector component 122 of the augmentation system 120 may receive an image 108 with a first virtual object 116-1 representing a first real object 106-1. The image 108 may be captured via the digital camera 102 or the digital camera 302. The image 108 may also be retrieved from a computer readable medium of the local data store 119.

The logic flow 600 may retrieve a second virtual object representing a second real object at block 604. For example, the pattern detector component 122 and/or the augmentation component 128 may retrieve a second virtual object 117-1 representing a second real object 115-1. The second virtual object 117-1 may comprise a 2D or 3D image stored as part of a product catalog for a business enterprise, for example, such as in the remote product catalog 112 or the local product catalog 114.

The logic flow 600 may determine a location for the second virtual object on the first virtual object at block 606. For example, the pattern detector component 122 may determine a location for the second virtual object 117-1 on the first virtual object 116-1 based on a location parameter 124-1. The pattern detector component 122 may generate the location parameter 124-1 based on a defined pattern, such as defined patterns 202, 502, for example.

The logic flow 600 may determine a scale for the second virtual object at block 608. For example, the pattern detector component 122 may determine a scale for the second virtual object 117-1 relative to the first virtual object 116-1 based on a scale parameter 124-2. As with the location parameter 124-1, the pattern detector component 122 may generate the scale parameter 124-2 based on a defined pattern, such as defined patterns 202, 502, for example.

The logic flow 600 may augment the first virtual object with a scaled second virtual object at the determined location on the first virtual object at block 610. For example, the augmentation component 128 may create a scaled second virtual object 117-1 based on the scale parameter 124-2, and augment the first virtual object 116-1 with the scaled second virtual object 117-1 at the determined location on the first virtual object 116-1 based on the location parameter 124-1.

FIG. 7 illustrates an embodiment of an exemplary computing architecture 700 suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, the augmentation system 120, the client systems 310, 400, and the server system 330.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client systems 310, 400. The servers 804 may implement the server system 330. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 802 and the servers 804 may include various types of standard communication elements designed to be interoperable with the communications framework 806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 802 and a server 804 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of non-transitory computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving an image with a first virtual object representing a first real object;
retrieving a second virtual object representing a second real object;
determining a location for the second virtual object on the first virtual object;
determining a scale for the second virtual object; and
augmenting the first virtual object with a scaled second virtual object at the determined location on the first virtual object.

2. The computer-implemented method of claim 1, comprising receiving the image with the first virtual object from a camera for presentation on an electronic display.

3. The computer-implemented method of claim 1, comprising retrieving the second virtual object representing the second real object from a product catalog stored in a local data store or a remote data store.

4. The computer-implemented method of claim 1, comprising determining the location for the second virtual object on the first virtual object based on a pattern disposed on the first real object.

5. The computer-implemented method of claim 1, comprising determining the scale for the second virtual object relative to the first virtual object based on a pattern disposed on the first real object.

6. The computer-implemented method of claim 1, comprising determining an orientation for the second virtual object relative to the first virtual object based on a pattern disposed on the first real object.

7. The computer-implemented method of claim 1, comprising augmenting the first virtual object with the scaled second virtual object at the determined location on the first virtual object at an orientation for the scaled second virtual object relative to the first virtual object.

8. The computer-implemented method of claim 1, comprising determining a change in a pattern disposed on the first real object.

9. The computer-implemented method of claim 8, comprising augmenting the first virtual object with the scaled second virtual object at a new location on the first virtual object based on a change in location of the pattern for the first real object.

10. The computer-implemented method of claim 8, comprising augmenting the first virtual object with the scaled second virtual object at a new orientation for the scaled second virtual object relative to the first virtual object based on a change in orientation of the pattern for the first real object.

11. An article of manufacture comprising a storage medium containing instructions that when executed enable a system to:
receive an image with a first virtual object representing a first real object;
retrieve a second virtual object representing a second real object;
determine a location and scale for the second virtual object; and
augment the first virtual object with the second virtual object based on the determined location and the determined scale to form an augmented object.

12. The article of claim 11, further comprising instructions that when executed enable the system to render the augmented object in an image with a scaled version of the second virtual object at the determined location on the first virtual object.

13. The article of claim 11, further comprising instructions that when executed enable the system to determine the location and the scale for the second virtual object based on a pattern disposed on the first real object.

14. The article of claim 11, further comprising instructions that when executed enable the system to determine an orientation for the second virtual object relative to the first virtual object based on a pattern disposed on the first real object, and augment the first virtual object with the second virtual object based on the determined location, the determined scale, and the orientation to form the augmented object.

15. An apparatus, comprising:
a processor; and
a memory communicatively coupled to the processor, the memory to store an augmentation system for execution by the processor, the augmentation system comprising:
a pattern detector component operative to receive an image with a first virtual object representing a first real object, and determine a location parameter and a scale parameter for a second virtual object based on the first virtual object;
an augmentation component operative to retrieve the second virtual object representing a second real object from a data store, and augment the first virtual object with the second virtual object based on the location parameter and the scale parameter to form an augmented object; and
a rendering component operative to render the augmented object in the image with a scaled version of the second virtual object as indicated by the scale parameter at a location on the first virtual object as indicated by the location parameter.

16. The apparatus of claim 15, the pattern detector component operative to determine the location parameter based on a pattern disposed on the first real object, the pattern indicating a location for the second virtual object proximate to the first virtual object.

17. The apparatus of claim 15, the pattern detector component operative to determine the scale parameter based on a pattern disposed on the first real object, the pattern indicating a size for the second virtual object relative to the first virtual object.

18. The apparatus of claim 15, the pattern detector component operative to determine an orientation parameter based on a pattern disposed on the first real object, the pattern indicating an angle for the second virtual object corresponding to an angle of the first virtual object.

19. The apparatus of claim 18, the augmentation component operative to augment the first virtual object with the second virtual object based on the location parameter, the scale parameter and the orientation parameter to form the augmented object, and the rendering component operative to render the augmented object in the image with the scaled version of the second virtual object at the determined location on the first virtual object with the determined orientation of the second virtual object relative to the first virtual object.

20. The apparatus of claim 15, the pattern detector component operative to determine a change in a pattern disposed on the first real object and determine a new location parameter and a new orientation parameter based on the change in the pattern disposed on the first real object, and the augmentation component operative to augment the first virtual object with the second virtual object based on the new location parameter and the new orientation parameter to form a new augmented object.
